(19) United States
(12) Patent Application Publication
(10) Pub. No.: US 2003/0169886 A1
(43) Pub. Date: Sep. 11, 2003

(54) Method and apparatus for encoding mixed surround sound into a single stereo pair

(76) Inventor: Roger W. Boyce, Playa Del Rey, CA (US)

Correspondence Address: CHRISTIE, PARKER & HALE, LLP, 350 WEST COLORADO BOULEVARD, SUITE 500, PASADENA, CA, 91105, US

(21) Appl. No.: 10/241,984

(22) Filed: Sep. 12, 2002

Related U.S. Application Data
(63) Continuation of application No. 09/619,928, filed on Jul. 20, 2000, now abandoned.
Application No. 09/619,928 is a continuation of application No. 09/227,996, filed on Jan. 8, 1999, now abandoned.
Application No. 09/227,996 is a continuation of application No. 08/838,169, filed on Apr. 16, 1997, now abandoned.
Application No. 08/838,169 is a continuation of application No. 08/370,978, filed on Jan. 10, 1995, now abandoned.

(51) Int. Cl. H04R 5/00

(52) U.S. Cl. 381/1; 381/17

(57) ABSTRACT

A method and apparatus for encoding mixed surround sound into a single pair of stereo channels is disclosed. The method and apparatus of the present invention accurately preserves the magnitude and phase information needed to provide positional cues to the listener, and does not require the use of any special equipment for stereo playback. In an exemplary embodiment of the invention, a set of speakers are positioned around a recording head or “kuntskopf” in a manner which ensures maximum locational displacement at extremes of sound level and equalization. The recording head includes a pair of phase-accurate microphones for receiving and converting the spatially separated acoustic signals generated by the speakers into a pair of conventional stereo signals. The stereo signals are then passed to a stereo mastering system for recording.

### RELATED APPLICATIONS

This is a continuation of pending application Ser. No. 09/619,928, filed Jul. 20, 2000, which is a continuation of application Ser. No. 09/227,996, filed Jan. 8, 1999, which is a continuation of application Ser. No. 08/838,169, filed Apr. 16, 1997, which is a continuation of application Ser. No. 08/370,978, filed Jan. 10, 1995, now abandoned, all of which are incorporated by reference as if set forth herein in full.

### BACKGROUND OF THE INVENTION

1. Field of the Invention

The present invention relates to audio recording, and more particularly to a method and apparatus for rerecording and encoding mixed surround sound into a single pair of stereo channels, such that the spatial and phase information is maintained.

2. Description of the Prior Art

For many years, the problem of reproducing surround sound using a pair of stereo channels has been studied, with the desired goal of producing a low cost alternative to conventional surround sound systems. The term “surround sound” refers to one of several conventional systems for generating an audio environment which provides the illusions of being inside the sound. The goal of surround sound is to augment the listening experience, whether it is pure audio or part of an audio-visual experience such as a feature film, television or an electronic game.

Conventional surround sound systems include the Sony Dynamic Digital Sound (SDDS) system, the THX System from Lucas Entertainment, the DTS system from Universal Studios and the Dolby system from Dolby Laboratories. Existing surround sound systems typically include multiple speakers positioned around a room, and specialized hardware for driving the speakers to produce the surround sound effect. Each system also requires that the listener sit in a specific limited space defined by the positioning of the speakers in order to achieve the optimal surround sound effect. The existing systems are expensive and are available to only a small portion of the listening population.

Accordingly, there is a need for a method and apparatus for encoding mixed surround sound into a single stereo pair which does not require the use of any special hardware or extra speakers for playback, which uses existing audio recording equipment, which does not depend on the location of the listener within the room and which accurately maintains the magnitude and phase information needed to provide positional cues to the listener.

### SUMMARY OF THE INVENTION

The present invention is directed to an method and apparatus for encoding mixed surround sound into a single pair of stereo channels. The method and apparatus of the present invention accurately preserves the subtle magnitude and phase information needed to provide accurate positional cues to the listener.

In a first exemplary embodiment of the invention, a set of surround system speakers are positioned around a recording head or “kuntskopf” in a manner which ensures maximum locational displacement at the extremes of sound level and equalization. The recording head includes a pair of phase-accurate microphones for receiving and converting the spatially separated acoustic signals generated by the speakers into a pair of conventional stereo signals. The stereo signals are then passed to a stereo mastering system for digital or analog recording.

More particularly, a binaural encoding environment is created by positioning the speakers in an acoustic enclosure designed to optimize spatial reference from the speakers. The acoustic enclosure is acoustically insulated in order to minimize standing and reflected waves. In the first preferred embodiment, the dimensions of the acoustic enclosure are approximately 8 feet by 8 feet, with the top either open or closed.

A set of audio signals corresponding to previously recorded sound tracks may generated using any of a number of conventional media such as magnetic tape, film, digital tape, hard disk or optical disk. Alternatively, the audio signals may be recorded in the acoustic enclosure, using the latter as a dubbing stage. The audio signals are fed to a conventional mixing console where they are processed to form a set of surround sound signals. The surround sound signals are, in turn, used to drive the set of surround sound speakers.

The recording head is positioned at the center of the acoustic enclosure, at a point where the surround sound effect is most pronounced. The shape and mass of the recording head models the physical characteristics of the human head, and the phase-accurate microphones are located at positions corresponding to the eardrums of a human listener. Thus, the complex sound waveforms which reach the microphones are virtually the same as would reach the eardrums of a human listener placed in the enclosure. Therefore, the recorded stereo sounds are able to replicate the precise three-dimensional placement and movement of each surround sound when reproduced through conventional stereo headphones.

In an alternative embodiment of the invention, the set of surround system speakers are positioned around the recording head in a circular configuration. Additionally, the speakers which are positioned to the rear of the recording head are located farther away than the speakers located to the front of the head. Since the human perception of rear audio is generally less acute, the output of the rear speakers is boosted approximately 4 db over that of the front speakers, thereby enhancing the sounds generated by the rear speakers.

Using the method of the present invention, a complete surround sound mix consisting of multiple channels can be easily encoded into a single stereo pair. The resulting stereo pair will contain all of the complex magnitude and phase information needed to accurately reconstruct the surround sound using conventional audio system. Regardless of the complexity of the original mixed surround sound signals, the method of the present invention provides a simple and low-cost approach to encoding surround sound.

The key advantages of the present invention include the following. First, the encoding method of the present invention can be accomplished using conventional studio recording equipment. Additionally, the method will work with virtually any of the conventionally available surround sound speaker systems. Further, the method can be used both for composing new music and for remixing existing compositions. Finally, the encoded surround sound can be played back using any conventional stereo system equipped with headphones.

Further features and advantages of the present invention will be appreciated by a review of the following detailed description of the preferred embodiments taken in conjunction with the following drawings.

### BRIEF DESCRIPTION OF THE DRAWINGS

The present invention may be best understood by referring to the following detailed description of the preferred embodiments and the accompanying drawings, wherein like numerals denote like elements and in which:

FIG. 1 is a perspective view of an acoustic enclosure 100 for encoding surround sound into a single stereo pair in accordance with the present invention;

FIG. 2 is a top view of enclosure 100 of FIG. 1, showing a first configuration of speakers 110-122 and the position of an artificial recording head 124 containing phase-accurate microphones 128 and 130;

FIG. 3 is a perspective view of recording head 124, showing the location of phase-accurate microphone 130;

FIG. 4 is a functional block diagram of an apparatus 180 for communicating mixed surround sound signals to speakers 110-122, and for receiving stereo signals from recording head 124;

FIG. 5 is a top view of a second configuration 200 of speakers 110-122 and the position of an artificial recording head 124 containing phase-accurate microphones 128 and 130; and

FIG. 6 is a top view of a third configuration 300 of speakers 112-116 and 120-122 and the position of an artificial recording head 124 containing phase-accurate microphones 128 and 130.

### DETAILED DESCRIPTION OF THE PREFERRED EMBODIMENTS

The following exemplary discussion focuses on a method and apparatus for encoding mixed surround sound into a single stereo pair. The method and apparatus of the present invention does not require any special equipment, either for encoding the surround sound or for playback of the encoded stereo signals.

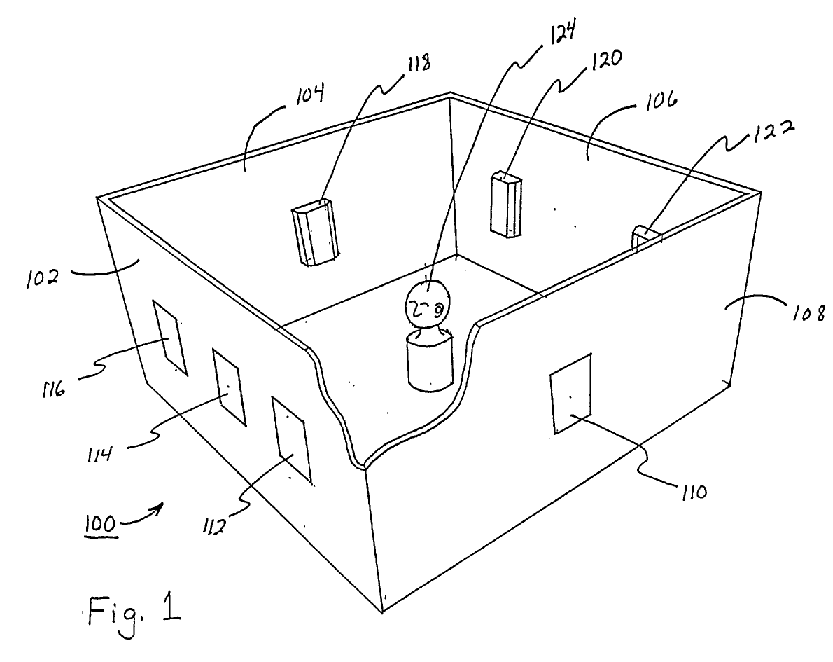

Referring to FIG. 1, a first preferred embodiment of an acoustic enclosure 100 for encoding mixed surround sound into a single stereo pair in accordance with the present invention, is shown. Enclosure 100 includes a front wall 102, a rear wall 106 and side walls 104 and 108 and, in the first preferred embodiment, the dimensions of enclosure 100 are approximately eight feet by eight feet. All of the walls may be constructed from conventional materials such as wood and plasterboard, with the interior surface of each of the walls being insulated with, for example, Illbruck 3-inch Sonex acoustical material, to absorb unwanted standing and reflected waves.

A set of surround sound speakers 110-122 are mounted to the interior surfaces of each wall. Alternatively, speakers 110-122 may sit on floor-mounted stands to allow for easy re-positioning. Speakers 110-122 may consist of any type of high quality, broad-bandwidth monitoring or studio speaker

In the first preferred embodiment, speakers 110-122 comprise seven Genelec Model 1031A broadband monitoring speakers (available from Genelec Oy, Iisalmi, Finland). Three speakers 112-116 are mounted on front wall 102, two speakers 120-122 are mounted on rear wall 106, and speakers 118 and 110 are mounted on side walls 104 and 108, respectively. More generally, the positioning of speakers 110-122 is selected to create a binaural encoding environment which optimizes the spatial reference from each of speakers 110-122.

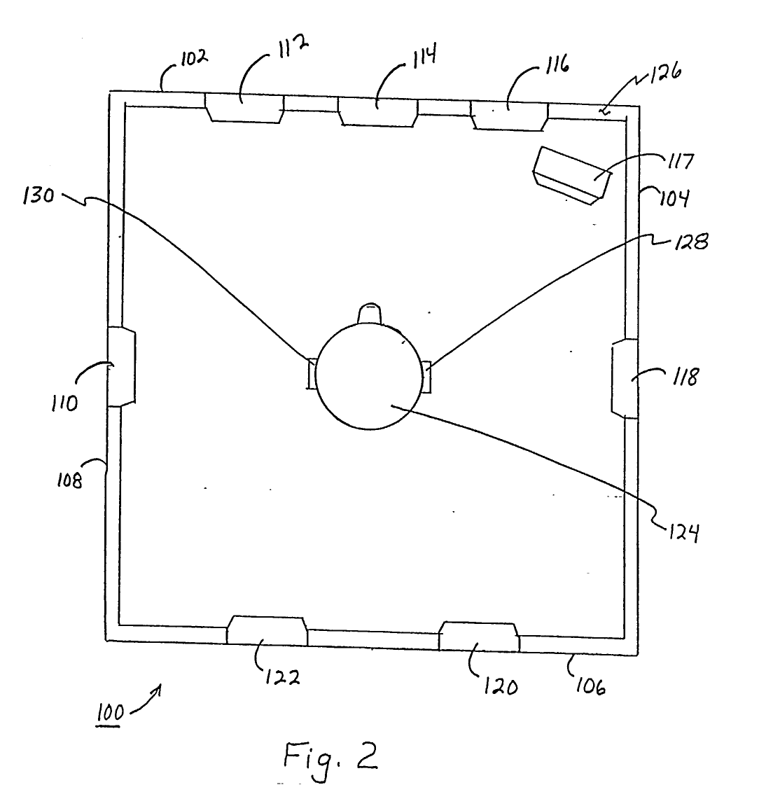

Continuing with FIG. 1, a recording head 124 is positioned at the center of acoustic enclosure 100, at a point where the surround sound effect is most pronounced. In the first preferred embodiment, recording head 100 comprises a model KU 100 dummy head (available from Georg Neumann, GMBH, Berlin). The shape and. mass of recording head 124 closely models the physical characteristics of the human head, and a pair of phase-accurate microphones 128 and 130 (FIG. 2) are located at positions corresponding to the eardrums of a human listener. Thus, the complex sound waveforms which reach microphones 128 and 130 are virtually the same as would reach the eardrums of a human listener placed at the same location within enclosure 100. Therefore, the recorded stereo sounds are able to replicate the precise three-dimensional placement and movement of each surround sound when reproduced through conventional stereo headphones.

Recording head 124 may alternatively be positioned on a simple pedestal, or may be mounted to a more complex three-dimensional model of the human body.

Referring now to FIG. 2, a top view of enclosure 100 which shows the configuration of speakers 110-122 and the position of recording head 124 is shown. As shown in FIG. 2, speakers 110-122 are positioned around recording head 124 in a manner which ensures maximum locational displacement at the extremes of sound level and equalization. More particularly, speakers 112-116 generate sounds corresponding to physical sources located in front of recording head 124. Similarly, speakers 120 and 122 generate sounds corresponding to physical sources located behind recording head 124. Speakers 110 and 118 generate sounds corresponding to physical sources located, respectively, to the left and right of recording head 124.

For example, in visual entertainment systems such as television or interactive games, the locations of physical sources can be dynamically adjusted in synchronization with the visual action. A sound which first emanates from the front of the listener can be panned to the side and back of the listener, thus simulating movement by the source. When combined with changes in sound level and equalization, the overall effect places the listener “inside” the sound.

Continuing with FIG. 2, recording head 124 is positioned at the center of enclosure 100, with phase-accurate microphones 128 and 130 oriented relative to speakers 110-122 as shown. The specific sounds received by microphones 128 and 130 result from constructive and destructive interference between the sounds generated by each of speakers 110-122.

Stated differently, the sounds generated by each of speakers 110-122 comprise complex acoustic waveforms having specific magnitudes and phases. Additionally, since each of speakers 110-122 is located at a different three-dimensional position relative to recording head 124, each sound travels a different distance and from a different direction to reach microphones 128 and 130. Further, the shape and mass of recording head 124, coupled with the locations of microphones 128 and 130 on the sides of recording head 124, also modify the sounds received by the microphones. These differences in sound magnitude, phase, distance and direction, along with the recording head shape and mass, are algebraically summed by microphones 128 and 130 to form a pair of stereo signals in which the three-dimensional spatial information of the corresponding physical sources is encoded.

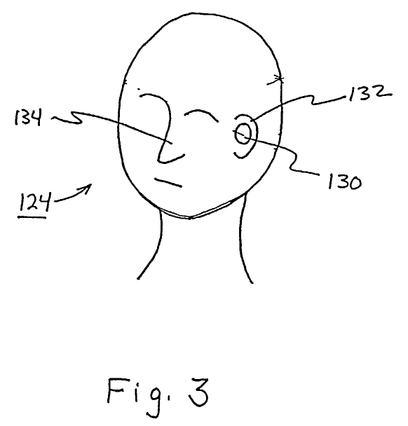

Referring FIG. 3, a perspective view of recording head 124, showing the location of phase-accurate microphones 128 and 130 is shown. As mentioned above in connection with FIG. 1, recording head 124 models the shape, mass, size and other physical characteristics of the human head. As shown schematically in FIG. 3, facial features 134 and ears 132 are included in the modeled physical characteristics.

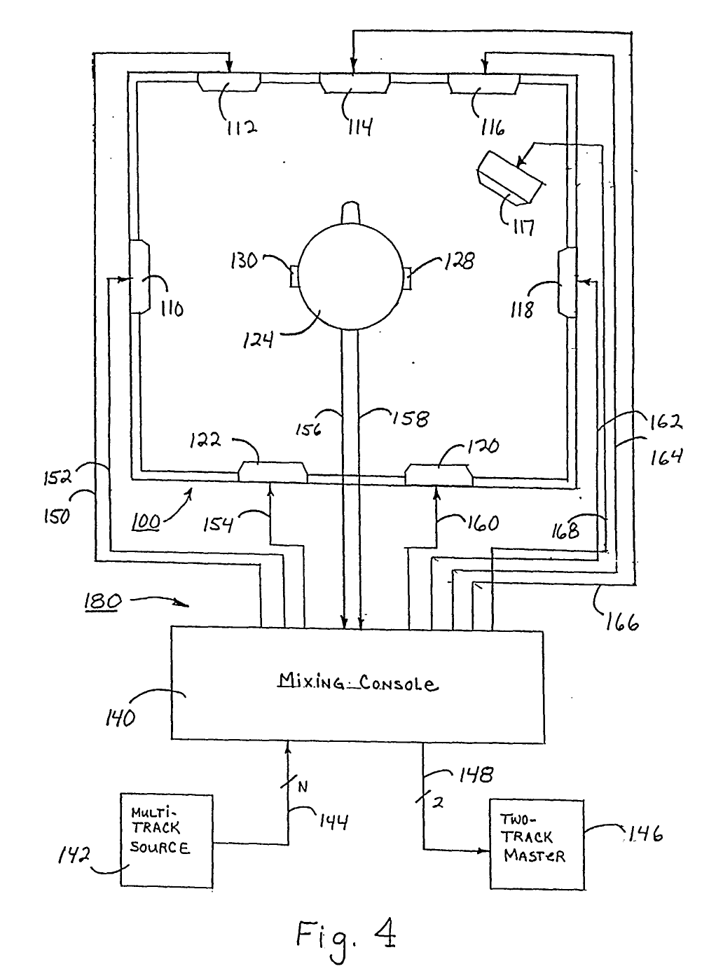

FIG. 4 is functional block diagram which illustrates a mixing and control apparatus 180 for communicating mixed surround sound signals to speakers 110-122, and for receiving stereo signals from recording head 124. Mixing and control apparatus 180 includes a mixing console 140, a multi-track sound source 142 and a two-track mastering device 146. In the preferred embodiment, multi-track sound source 142 comprises a Sony APR-24 analog two-inch magnetic tape machine. Alternatively, sound source 142 may comprise any conventional multi-track sound source, such as magnetic film stock or a Studio Frame DAW 80 digital audio workstation.

Each recorded track of multi-track sound source 142 contains sounds for a single sound source, such as a musical instrument, a voice, a jet plane or any other physical object or device. Any one or combination of the tracks may be accessed and played back, and the multi-track signals generated by the playback are transferred to mixing console 140 via multi-channel signal path 144.

Mixing console 140 receives the multi-track signals from source 142, and mixes the signals to form a reduced number of surround sound signals for driving speakers 110-122. More particularly, mixing console 140 provides controls for adjusting the individual level and equalization of each multi-track signal, and for combining the adjusted signals to form the surround sound signals. In the preferred embodiments, mixing console 140 comprises a Harrison MPC console which is capable of mixing at least 60 multi-track signals to form seven surround sound signals which, in turn, drive speakers 110-122 via signal paths 150-154 and 160-166.

Mixing console 140 also monitors the stereo signals formed by microphones 128 and 130. Specifically, mixing console 140 receives the stereo signals from microphones 128 and 130 via signal paths 156 and 158. An operator may listen to the received stereo signals using a pair of stereo headphones (not shown).

Continuing with FIG. 4, two-track mastering device 146 is connected to mixing console 140 via two-channel signals path 148. In the first preferred embodiment, mastering device 146 may comprise a Sony DTC-59ES digital audio tape (DAT) machine, any two channels of a digital multi-track recorder or 2-stripe magnetic film stock. Mastering device 146 receives the stereo signals from mixing console 140 and records them on separate right and left stereo tracks.

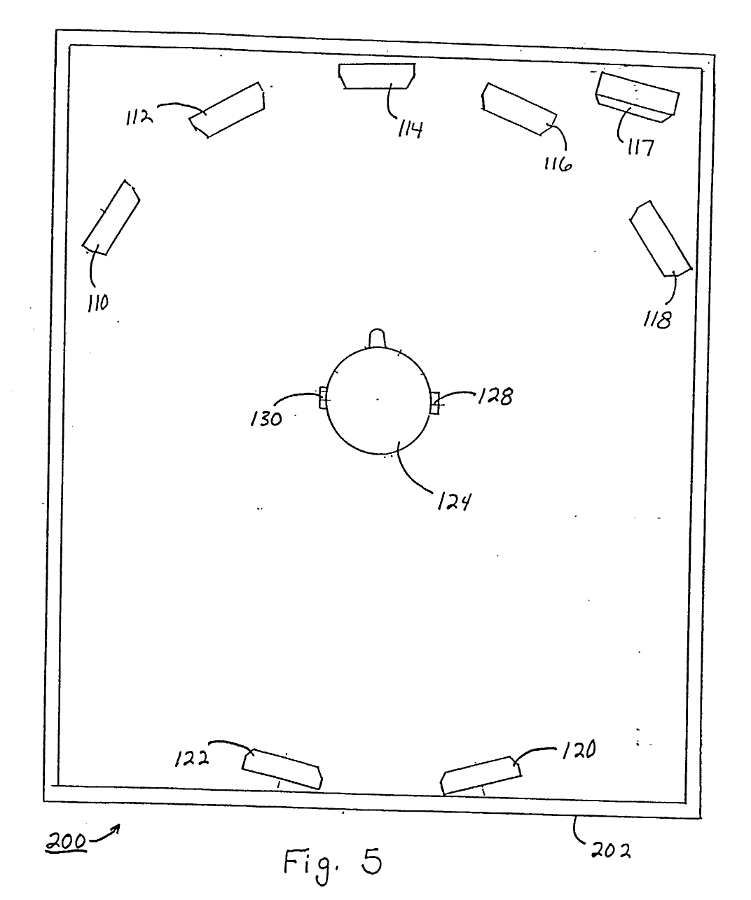

Referring to FIG. 5, a top view of a second configuration 200 of speakers 110-122 positioned relative to recording head 124 is shown. In configuration 200, five speakers 110-118 are positioned along a first arc adjacent to recording head 124. Specifically, speakers 112-116 are positioned along the arc adjacent to the front of recording head 124, while speakers 110 and 118 are positioned adjacent to the respective left and right sides of recording head 124. Additionally, speakers 120 and 122 are positioned along a second arc adjacent to the rear side of recording head 124, as shown. Note that the radius of the second arc may be longer than that of the first arc in order to increase the sense of depth from speakers 120-122.

Continuing with FIG. 5, in the second preferred embodiment the signal levels of the audio signals which drive rear speakers 120 and 122 are set at about 4 decibels higher than the signals driving speakers 110-118. This boosting is done because rear depth perception is less acute, so that while placing speakers 120-122 further back increases the sense of depth, level boosting is˜ needed to accentuate the hard to localize. sound source. The result is an improvement in localization of signals emanating from the rear of the listener.

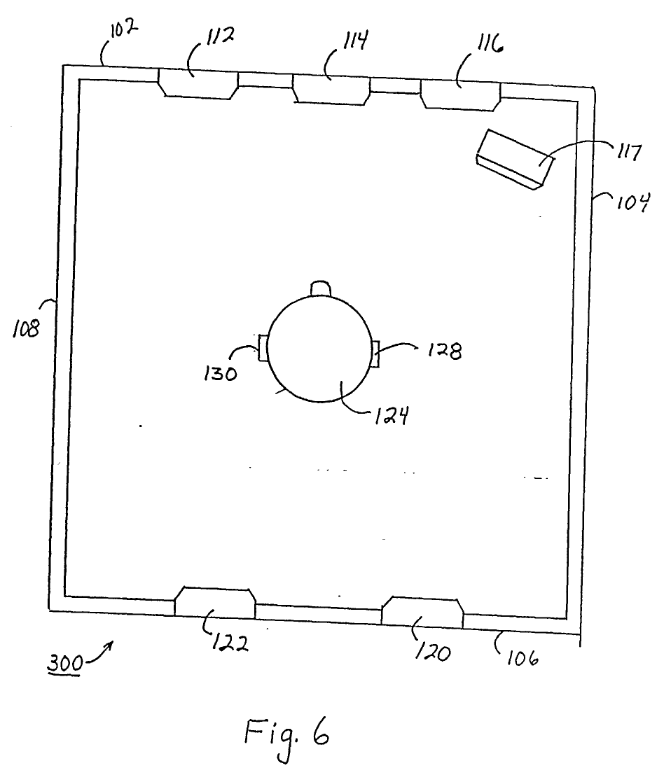

Referring to FIG. 6, a top view of a third configuration 300 of speakers 112-116 and 120-122 positioned relative to recording head 124 is shown. In configuration 300, three speakers 112-116 mounted on front wall 102, two speakers 120-122 mounted on rear wall 106. Additionally, speakers 120-122 may be high-pass filtered to remove the low frequency components, thereby allowing speakers 120-122 to be driven with higher power signals without distortion.

In all of the above described embodiments, a sub-woofer speaker 117 may be added to enhance the low frequency response. The placement of sub-woofer 117 within the acoustic enclosures is not important, since the associated low frequencies (typically 30 hertz) are very non-directional. Alternatively, the sub-woofer frequencies may be added directly by mixing console 140.

A preferred method for encoding surround sound into a single stereo pair includes the following steps. In the first step, speakers 110-122 are positioned within acoustic enclosure 100 and around recording head 124, in a configuration which ensures maximum locational displacement at extreme sound level and sound equalization. In step two, a set of multi-track signals is generated Using multi-track sound source 142, and the multi-track signals are communicated to mixing console 140. Note that when dubbing to picture (film or video) multi-track sound source 142 and two-track mastering device 146 also are synchronized to the picture during step two.

In the third step, the multi-track signals are mixed to form one or more mixed audio signals, which are then communicated to speakers 110-122. In step four, the outputs of phase-accurate microphones 128 and 130 are monitored and recorded using mixing console 140 and two-track mastering device 140.

Thus, the present invention does not require the use of any special hardware for playback, but instead uses only conventional stereo equipment. Additionally, the present invention uses existing commercial recording equipment for encoding the surround sound into the single stereo pair. Further, the present invention accurately maintains the subtle magnitude and phase information needed to provide positional cues to the listener

The foregoing description includes what are at present considered to be preferred embodiments of the invention. However, it will be readily apparent to those skilled in the art that various changes and modifications may be made to the embodiments without departing from the spirit and scope of the invention. For example, the size and shape of the acoustic enclosure or the number, type and configuration of the speakers may be changed. Accordingly, it is intended that such changes and modifications fall within the spirit and scope of the invention, and that the invention be limited only by the following claims.

What is claimed is:

1. A method for encoding mixed surround sound into a single stereo channel, said mixed surround sound including a plurality of spatially separated acoustic signals, and said single stereo channel including a pair of stereo signals, said method comprising the steps of:
positioning a plurality of speakers around a recording head, said positioning for ensuring maximum locational displacement at extreme sound level and sound equalization, said plurality of speakers for generating said spatially separated acoustic signals, and said recording head including a pair of phase-accurate microphones for receiving said spatially separated acoustic signals and for converting said spatially separated acoustic signals into said pair of stereo signals;
generating one or more first audio signals, said one or more first audio signals for driving said plurality of speakers; and
recording said pair of stereo signals to form said encoded stereo channel.

2. The method of claim 1 wherein said step of positioning said plurality of speakers further comprises the step of positioning said plurality of speakers in a rectangular configuration around said recording head.

3. The method of claim 2 wherein said plurality of speakers comprises seven speakers, and wherein said step of positioning said plurality of speakers in said rectangular configuration around said recording head further comprises the steps of:
positioning three speakers along a first side of said rectangular configuration;
positioning two speakers along a second side of said rectangular configuration, said second side being opposite to said first side;
positioning one speaker along a third side of said rectangular configuration, said third side being adjacent to said first side and said second side; and
positioning one speaker along a fourth side of said rectangular configuration, said fourth side being adjacent to said first side and said second side and opposite to said third side.

4. The method of claim 1 wherein said step of positioning said plurality of speakers further comprises the step of positioning said plurality of speakers in a circular configuration around said recording head.

5. The method of claim 4 wherein said plurality of speakers comprises seven speakers and said recording head includes a front side, a rear side, a right side, a left side and a geometrical center, and wherein said step of positioning said plurality of speakers in said circular configuration around said recording head further comprises the steps of:
positioning five speakers along a first arc adjacent to said recording head, three of said five speakers positioned adjacent to said front side of said recording head, one of said five speakers positioned adjacent to said left side of said recording head, and one of said five speakers positioned adjacent to said right side of said recording head, said first arc having a first radius which is centered at said geometrical center of said recording head; and
positioning two speakers along a second arc adjacent to said rear side of said recording head, said second arc having a second radius which is centered at said geometrical center of said recording head.

6. The method of claim 1 wherein said step of positioning said plurality of speakers further comprises the step of spatially positioning said plurality of speakers within an acoustic enclosure, said acoustic enclosure for optimizing spatial reference of said spatially separated acoustic signals from said plurality of speakers.

7. The method of claim 6 wherein said step of positioning said plurality of speakers further comprises the step of positioning said plurality of speakers in a rectangular configuration around said recording head.

8. The method of claim 7 wherein said plurality of speakers comprises seven speakers, and wherein said step of positioning said plurality of speakers in said rectangular configuration around said recording head further comprises the steps of:
positioning three speakers along a first side of said rectangular configuration;
positioning two speakers along a second side of said rectangular configuration, said second side being opposite to said first side;
positioning one speaker along a third side of said rectangular configuration, said third side being adjacent to said first side and said second side; and
positioning one speaker along a fourth side of said rectangular configuration, said fourth side being adjacent to said first side and said second side and opposite to said third side.

9. The method of claim 6 wherein said step of positioning said plurality of speakers further comprises the step of positioning said plurality of speakers in a circular configuration around said recording head.

10. The method of claim 9 wherein said plurality of speakers comprises seven speakers and said recording head includes a front side, a rear side, a right side, a left side and a geometrical center, and wherein said step of positioning said plurality of speakers in said circular configuration around said recording head further comprises the steps of:
positioning five speakers along a first arc adjacent to said recording head, three of said five speakers positioned along said first arc adjacent to said front side of said recording head, one of said five speakers positioned along said first arc adjacent to said left side of said recording head, and one of said five speakers positioned along said first arc adjacent to said right side of said recording head, said first arc having a first radius which is centered at said geometrical center of said recording head; and
positioning two speakers along a second arc adjacent to said rear side of said recording head, said second arc having a second radius which is centered at said geometrical center of said recording head.

11. The method of claim 1 wherein said step of generating one or more first audio signals further comprises the step of generating one or more audio signals each of which corresponds to one or more first sound tracks containing recorded sounds.

12. The method of claim 1 wherein said step of generating one or more first audio signals further comprises the step of mixing said one or more audio signals to form one or more mixed surround sound signals.

13. The method of claim 1 wherein said step of generating one or more first audio signals further comprises the step of communicating said mixed surround sound signals to said plurality of speakers.

14. A method for encoding mixed surround sound into a single stereo channel, said mixed surround sound including a plurality of spatially separated acoustic signals, and said single stereo channel including a pair of stereo signals, said method comprising the steps of:
spatially positioning a plurality of speakers within an acoustic enclosure, said positioning for ensuring maximum locational displacement at extreme sound level and sound equalization, said plurality of speakers for generating said spatially separated acoustic signals, and said acoustic enclosure for optimizing spatial reference of said spatially separated acoustic signals from said plurality of speakers;
positioning a recording head within said acoustic enclosure, said recording head including a pair of phase-accurate microphones for receiving said spatially separated acoustic signals and for converting said spatially separated acoustic signals into said pair of stereo signals;
generating one or more audio signals, each of said one or more audio signals corresponding to one or more first sound tracks containing recorded sounds;
mixing said one or more audio signals to form one or more mixed surround sound signals;
communicating said mixed surround sound signals to said plurality of speakers; and
recording said pair of stereo signals onto a pair of second sound tracks.

15. The method of claim 14 wherein said step of positioning said plurality of speakers further comprises the step of positioning said plurality of speakers in a rectangular configuration around said recording head.

16. The method of claim 15 wherein said plurality of speakers comprises seven speakers, and wherein said step of positioning said plurality of speakers in said rectangular configuration around said recording head further comprises the steps of:
positioning three speakers along a first side of said rectangular configuration;
positioning two speakers along a second side of said rectangular configuration, said second side being opposite to said first side;
positioning one speaker along a third side of said rectangular configuration, said third side being adjacent to said first side and said second side; and
positioning one speaker along a fourth side of said rectangular configuration, said fourth side being adjacent to said first side and said second side and opposite to said third side.

17. The method of claim 14 wherein said step of positioning said plurality of speakers further comprises the step of positioning said plurality of speakers in a circular configuration around said recording head.

18. The method of claim 17 wherein said plurality of speakers comprises seven speakers and said recording head includes a front side, a rear side, a right side, a left side and a geometrical center, and wherein said step of positioning said plurality of speakers in said circular configuration around said recording head further comprises the steps of:
positioning five speakers along a first arc adjacent to said recording head, three of said five speakers positioned adjacent to said front side of said recording head, one of said five speakers positioned adjacent to said left side of said recording head, and one of said five speakers positioned adjacent to said right side of said recording head, said first arc having a first radius which is centered at said geometrical center of said recording head; and
positioning two speakers along a second arc adjacent to said rear-side of said recording head, said second arc having a second radius which is centered at said geometrical center of said recording head.

19. An apparatus for encoding mixed surround sound into a single stereo channel, said mixed surround sound including a plurality of spatially separated acoustic signals, and said single stereo channel including a pair of stereo signals, said apparatus comprising:
a recording head including a pair of phase-accurate microphones for receiving one or more spatially separated acoustic signals and for converting said spatially separated acoustic signals into said pair of stereo signals;
a plurality of speakers positioned around said recording head, said positioning for ensuring maximum locational displacement at extreme sound level and sound equalization, said plurality of speakers for generating said spatially separated acoustic signals;
a device for generating one or more first audio signals, said one or more first audio signals for driving said plurality of speakers; and
a device for recording said pair of stereo signals to form said encoded stereo channel.

20. The apparatus of claim 1 further comprising an acoustic enclosure, said acoustic enclosure for optimizing spatial reference of said spatially separated acoustic signals from said plurality of speakers.

21. The apparatus of claim 20 wherein said plurality of speakers further comprises:
three speakers positioned along a first side of said acoustic enclosure;
two speakers positioned along a second side of said acoustic enclosure, said second side being opposite to said first side;
one speaker positioned along a third side of said acoustic enclosure, said third side being adjacent to said first side and said second side; and
one speaker positioned along a fourth side of said acoustic enclosure, said fourth side being adjacent to said first side and said second side and opposite to said third side.

22. The apparatus of claim 20 wherein said plurality of speakers further comprises:
five speakers positioned along a first arc adjacent to said recording head, three of said five speakers positioned along said first arc adjacent to a front side of said recording head, one of said five speakers positioned along said first arc adjacent to a left side of said recording head, and one of said five speakers positioned along said first arc adjacent to a right side of said recording head, said first arc having a first radius which is centered at a geometrical center of said recording head; and
two speakers positioned along a second arc adjacent to a rear side of said recording head, said second arc having a second radius which is centered at said geometrical center of said recording head.

23. The apparatus of claim 20 wherein said device for generating said one or more first audio signals further comprises:
a multi-track sound source for generating said one or more first audio signals; and
a mixing device for mixing said one or more first audio signals to form one or more mixed surround sound signals, said mixing device coupled to said multi-track sound source and said plurality of speakers.

24. The apparatus of claim 20 wherein said device for recording said pair of stereo signals further comprises a two-track mastering device.
